(19) United States
(12) Patent Application Publication
(10) Pub. No.: US 2014/0055408 A1
(43) Pub. Date: Feb. 27, 2014

(54) ELECTRONIC BUTTON AND RELATED PANEL MODULE AND RELATED ELECTRONIC DEVICE

(71) Applicant: PIXART IMAGING INC., Hsin-Chu City (TW)

(72) Inventors: Tien-Chia Liu, Hsin-Chu City (TW); Hung-Ching Lai, Hsin-Chu City (TW); Chun-Chen Chen, Hsin-Chu City (TW)

(73) Assignee: PIXART IMAGING INC., Hsin-Chu City (TW)

(21) Appl. No.: 13/771,102

(22) Filed: Feb. 20, 2013

(30) Foreign Application Priority Data
Aug. 27, 2012 (TW) 101130993

(51) Int. Cl. G06F 3/041

(52) U.S. Cl. CPC G06F 3/041
USPC 345/174; 345/173

(57) ABSTRACT

An electronic button applied to a touch panel is disclosed in the present invention. The electronic button includes a switch and a transparent conductive structure. The switch is electrically connected to the touch panel for switching functions of the touch panel. The transparent conductive structure is electrically connected to the switch and disposed on a surface of the touch panel. The transparent conductive structure transmits a current, and a reference value of the current is varied when an external object contacts the transparent conductive structure, so as to drive the switch to power on and to power off the touch panel.

### BACKGROUND OF THE INVENTION

1. Field of the Invention

The present invention relates to an electronic button, and more particularly, to an electronic button made by a transparent conductive structure and a related panel module and a related electronic device.

2. Description of the Prior Art

A conventional transparent conductive membrane is applied to a display industry, such as a liquid crystal display, a solar panel and a touch panel. The liquid crystal display utilizes the transparent conductive membrane to transmit electronic signal between the thin-film transistor (TFT) array and the color filter. The conventional transparent conductive membrane has properties of low resistance, high transmittance and high conductivity, so as to be disposed on a transparent electrode of the display for uniformly current transmission. In addition, the conventional transparent conductive membrane can further be an anti-reflection membrane and a thermo reflective membrane for power economy due to its specific optical characteristic. The conventional transparent conductive membrane does not utilize the conductivity to form a functional switch for power execution. Therefore, design of an electronic button on the display by the transparence and the transmittance of the transparent conductive membrane is an important issue of the electronic industry.

### SUMMARY OF THE INVENTION

The present invention provides an electronic button made by a transparent conductive structure and a related panel module and a related electronic device for solving above drawbacks.

According to the claimed invention, an electronic button applied to a touch panel is disclosed. The electronic button includes a switch and a transparent conductive structure. The switch is electrically connected to the touch panel for switching operational functions of the touch panel. The transparent conductive structure is electrically connected to the switch and disposed on a surface of the touch panel. The transparent conductive structure transmits a current, and a reference value of the current is varied when an external object contacts the transparent conductive structure, so as to drive the switch to power on and to power off the touch panel.

According to the claimed invention, an electronic button applied to a touch panel is disclosed. The electronic button includes a switch and a conductive membrane. The switch is electrically connected to the touch panel for switching operational functions of the touch panel. The conductive membrane is electrically connected to the switch, and disposed on a surface of the touch panel. The conductive membrane transmits a current, and a reference value of the current is varied when an external object contacts the conductive membrane, so as to drive the switch to power on and to power off the touch panel.

According to the claimed invention, a panel module includes a touch panel, a power supply and an electronic button. The touch panel detects an external object. The electronic button is disposed on the touch panel. The electronic button includes a switch and a transparent conductive structure. The switch is electrically connected to the touch panel for switching operational functions of the touch panel. The transparent conductive structure is electrically connected to the switch and disposed on a surface of the touch panel. The transparent conductive structure transmits a current, and a reference value of the current is varied when an external object contacts the transparent conductive structure, so as to drive the switch to power on and to power off the touch panel.

According to the claimed invention, an electronic device includes a casing, a panel module and a controller. The panel module is disposed on a surface of the casing. The panel module includes a touch panel, a power supply and an electronic button. The touch panel detects an external object. The electronic button is disposed on the touch panel. The electronic button includes a switch and a transparent conductive structure. The switch is electrically connected to the touch panel for switching operational functions of the touch panel. The transparent conductive structure is electrically connected to the switch and disposed on a surface of the touch panel. The transparent conductive structure transmits a current, and a reference value of the current is varied when an external object contacts the transparent conductive structure, so as to drive the switch to power on and to power off the touch panel. The controller is electrically connected to the touch panel. The controller outputs a command according to detection of the external object by the touch panel.

The present invention transmits the stable minority current into the transparent conductive structure, the current variation is generated when the external object contacts the transparent conductive structure, so the transparent conductive structure can be combined with the switch to be the electronic button to power on and to power off the touch panel. The present invention disposes the transparent conductive structure with the great transmittance on the optical touch panel to form the electronic button. Thus, the optical electronic device of the present invention does not capture the unexpected movement of the external object, and can accurately determine indication of the user for outputting the correct command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the present invention.

FIG. 2 is a diagram of a part of the electronic device according to the embodiment of the present invention.

FIG. 3 is a diagram of a touch panel according to the embodiment of the present invention.

FIG. 4 is a diagram of a touch panel according to the other embodiment of the present invention.

FIG. 5 is a diagram of a touch panel according to the other embodiment of the present invention.

FIG. 6 is a diagram of a touch panel according to the other embodiment of the present invention.

### DETAILED DESCRIPTION

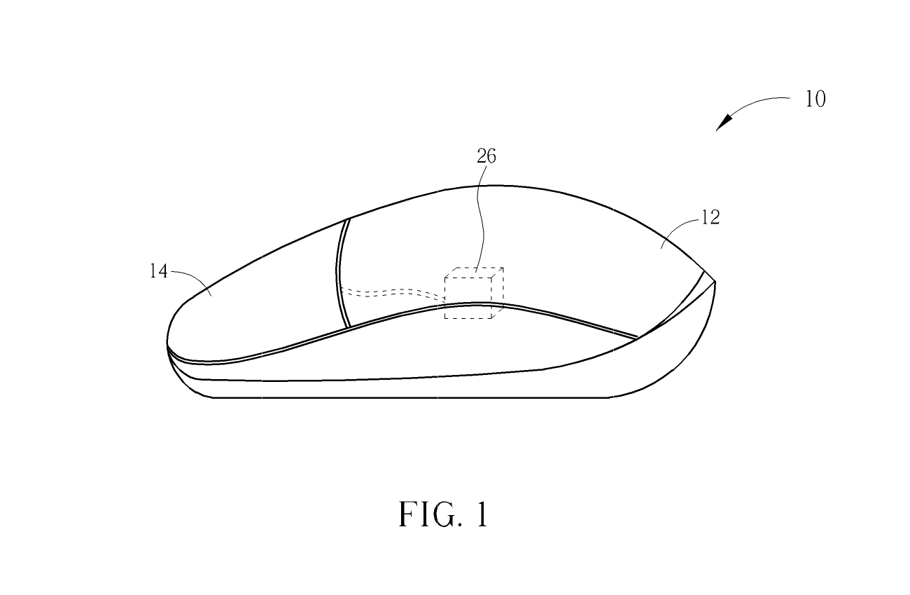

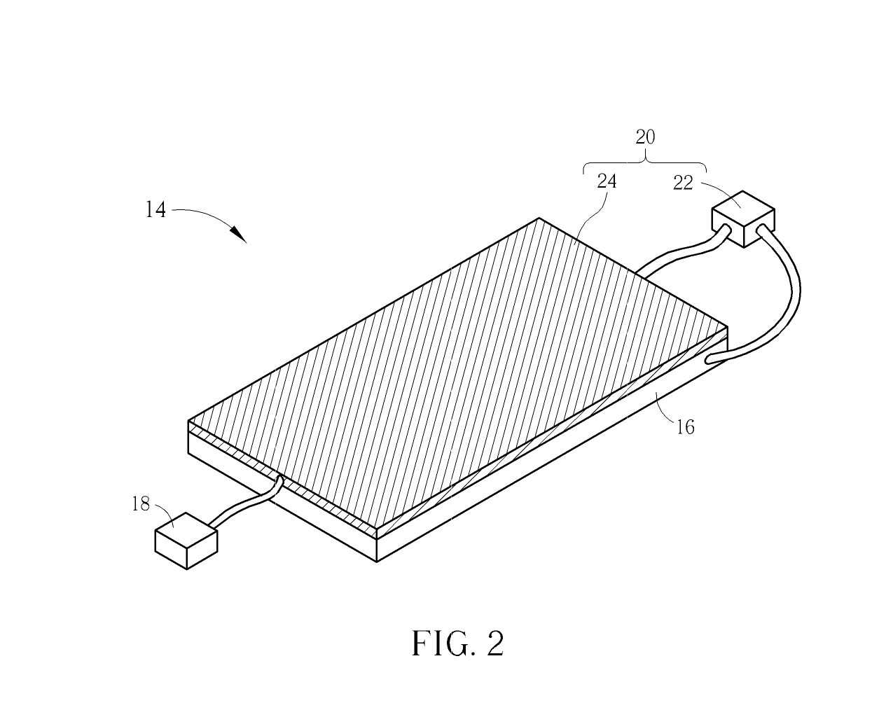

Please refer to FIG. 1 and FIG. 2. FIG. 1 is a diagram of an electronic device 10 according to an embodiment of the present invention. FIG. 2 is a diagram of a part of the electronic device 10 according to the embodiment of the present invention. The electronic device 10 includes a casing 12 and a panel module 14. The casing 12 covers a plurality of electronic components of the electronic device 10, the electronic components can be a circuit board, a processor, a transmission cable and so on. The panel module 14 is disposed on a surface of the casing 12. The panel module 14 can be used to control operation of the electronic components inside the electronic device 10 by optical reflection and optical shelter. For example, the electronic device 10 can be an optical mouse or a touch panel having touch operational function.

The panel module 14 includes a touch panel 16, a power supply 18 and an electronic button 20. As shown in FIG. 2, the touch panel 16 can be a flat structure, and can further be manufactured to form a curved structure for being disposed on the casing 12. The touch panel 16 can detect a movement of an external object, such as a user's finger or a stylus. The power supply 18 can be a direct current (DC) power supply, which outputs a stable current to the electronic button 20. The electronic button 20 is disposed on the touch panel 16. The electronic button 20 includes a switch 22 and a transparent conductive structure 24. The switch 22 is electrically connected to the touch panel 16, and the transparent conductive structure 24 is electrically connected between the switch 22 and the power supply 18. The current outputted by the power supply 18 can uniformly transmit to the switch 22 through the transparent conductive structure 24. The transparent conductive structure 24 is disposed on a surface of the touch panel 16, so that the user can press the transparent conductive structure 24 to vary a reference value of the current for actuating the switch 22, and then to start the operation of the touch panel 16.

In addition, the electronic device 10 further includes a controller 26 electrically connected to the touch panel 16, as shown in FIG. 1. When the user utilizes the electronic button 20 to power on the panel module 14, the touch panel 16 can be simultaneously actuated to detect the movement of the external object. Then, the controller 26 can output a command according to detection of the touch panel 16, so as to control an external apparatus. For example, the external apparatus can include a host and a screen, the electronic device 10 can be an input interface for controlling the external apparatus. The electronic device 10 can output the command to execute the corresponding program on the host, and further display the execution result on the screen.

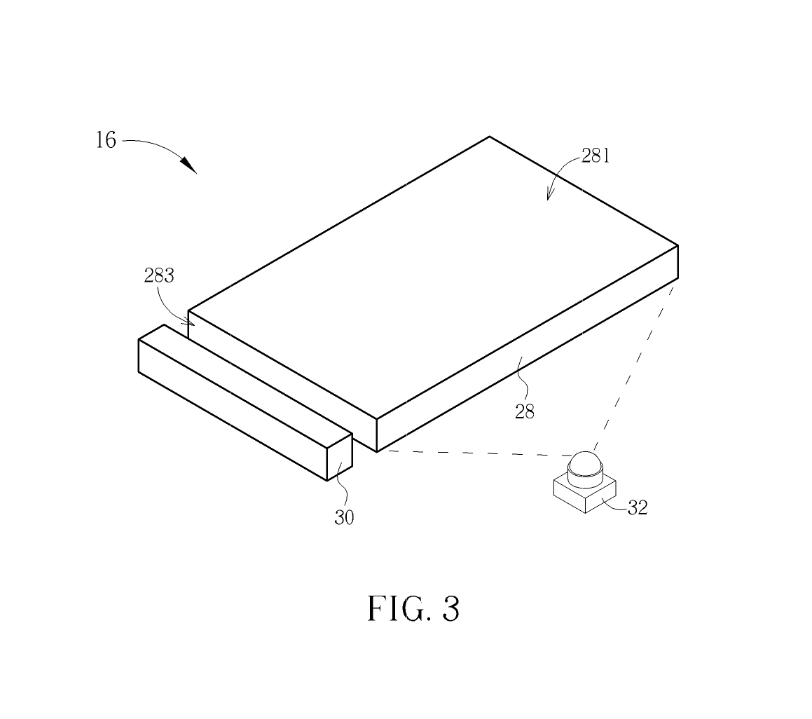

Please refer to FIG. 3. FIG. 3 is a diagram of the touch panel 16 according to the embodiment of the present invention. The touch panel 16 can include a light guide plate 28, a light unit 30 and an optical detector 32. The light guide plate 28 can include a light emitting surface 281 and a light incident surface 283. The light unit 30 can be a combination of a light emitting diode and a light guide bar, and is disposed by a side of the light guide plate 28. The light unit 30 provides a light beam into the light guide plate 28 via the light incident surface 283, and the light beam is outputted from the light emitting diode and is transmitted inside the light guide plate 28 by total internal reflection. Particle or pattern can be disposed on a lower surface inside the light guide plate 28 for damaging the total internal reflection, so that the light beam can be transmitted out of the light guide plate 28 through the light emitting surface 281. The optical detector 32 can be disposed under the light guide plate 28. The optical detector 32 receives a reflective optical signal generated from the external object when the external object is placed on the light emitting surface 281, and the controller 26 can analyze the detection of the optical detector 32, so as to output the corresponding command to control the external apparatus. The detecting mechanism of the touch panel 16 is not limited to the above-mentioned embodiment, and depends on design demand. For example, the total internal reflection can be damaged by putting the finger on the light emitting surface 281, so as to transfer the light beam toward the optical detector 32.

The present invention disposes the transparent conductive structure 24 on an upper surface (the light emitting surface 281) of the touch panel 16. The transparent conductive structure 24 and the switch 22 are combined to be the electronic button 20, which is utilized to power on and to power off the touch panel 16. Therefore, the present invention can prevent the optical detector 32 and the controller 26 from actuation when the electronic device 10 is not in use and the external object passes through or contacts the light guide plate 28 in accident. Generally, the transparent conductive structure 24 can be made of indium tin oxide (ITO) material, aluminum zinc oxide (AZO) material or gallium-doping zinc oxide (GZO) material. Material of the transparent conductive structure 24 is not limited to the above-mentioned ones, any material with great transmittance, great conductivity and flexibility is proper to make the transparent conductive structure 24 of the present invention.

The optical detector 32 disposed on a side of the light guide plate 28 and the transparent conductive structure 24 can detect the movement of the external object placed on the other side of the light guide plate 28 and the transparent conductive structure 24. Because the reflective optical signal generated from the external object, which is put on the light emitting surface 281, may be varied by reflection and refraction when passing through the transparent material, the transparent conductive structure 24 has great transmittance to prevent the optical detector 32 from error detection. In addition, the transparent conductive structure 24 can transmit the current with the stable reference value. As the external object contacts the surface of the transparent conductive structure 24, the reference value of the current is interfered and varied, and the electronic button 20 can determine whether to actuate the touch panel 16 for outputting the command according to variation of the reference value. For example, the reference value of the current can be a voltage value, a current value or a resistance value, and depends on actual demand. The detailed forms of the reference value are omitted herein for simplicity.

First, the power supply 18 can output the stable current with a first value R1 to the transparent conductive structure 24, and the current is uniformly distributed over the transparent conductive structure 24. To power on the touch panel 16, the external object can contact the transparent conductive structure 24, which means the transparent conductive structure 24 is pressed and the external object enters a detective range of the optical detector 32. Meanwhile, the reference value of the current is varied. As the reference value is varied (decreased) from the first value R1 to a second value R2, the transparent conductive structure 24 can drive the switch 22 according to the variation of the reference value of the current, so as to power on the optical detector 22 for analyzing the movement of the external object above the light emitting surface 281.

The external object can be spaced from the transparent conductive structure 24 when the touch panel 16 is not in use. The finger or the stylus can be separated from the touch panel 14 and does not interfere with the current, so that the reference value of the current can be varied (increased) from the second value R2 to the first value R1. Thus, the switch 22 can power off the optical detector 22 to stop touch operational function of the touch panel 16 according to the variation of the reference value from the transparent conductive structure 24. In an embodiment, after the touch panel 16 is shut down, the optical detector 22 is not acted even through the external object moves above the light emitting surface 281, so as to effectively prevent the electronic device 10 from the error detection when the external object does not contact the panel module 14.

It should be mentioned that the transparent conductive structure 24 of the present invention can preferably be a flexible structure, so as to be the electronic button 20 to dispose on the touch panel 16. As shown in FIG. 1, the electronic device 10 can be the optical mouse, the casing 12 is an arch for ergonomic. The transparent conductive structure 24 can preferably be made of ITO material, which has advantages of great transmittance, great conductivity and flexibility, so the transparent conductive structure 24 is widespread applied to different kinds of input interface (the electronic device 10).

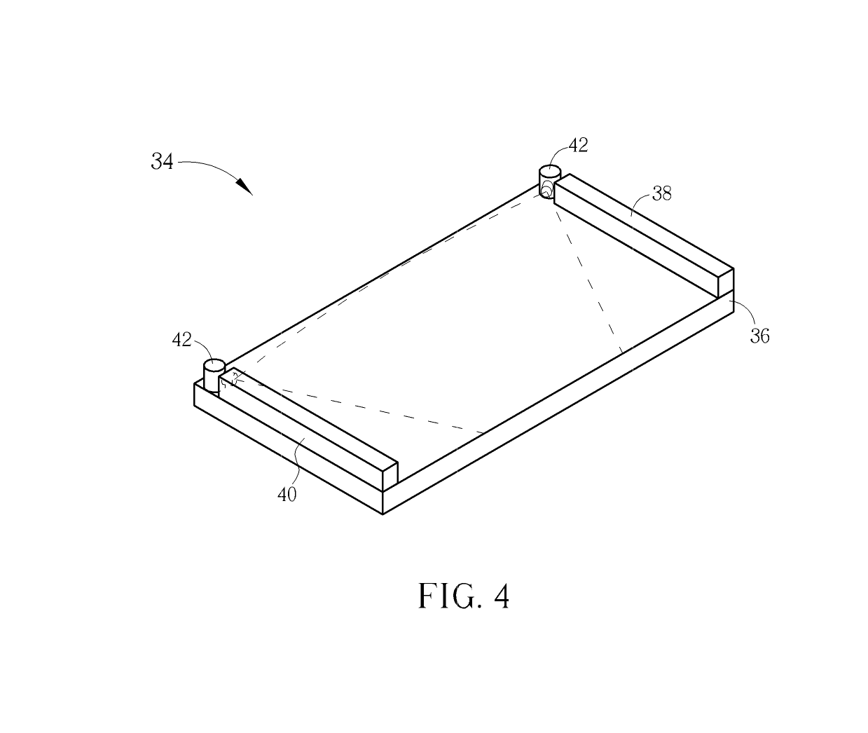

Please refer to FIG. 4. FIG. 4 is a diagram of a touch panel 34 according to the other embodiment of the present invention. The touch panel 34 can be an optical image touch screen. The optical image touch screen includes a base 36, a reflection bar 38, a light guide bar 40 and two image detectors 42. The reflection bar 38 is disposed on an edge of the base 36, the light guide bar 40 is disposed on the other edge of the base 36, and the image detectors 42 are respectively disposed on two adjacent corners of the base 36. The light guide bar 40 provides a light beam toward the reflection bar 38, the light beam is reflected by the reflection bar 38, and the image detector 42 receives the reflected light beam form the reflection bar 38. When the external object contacts the base 36 and the light beam is blocked by the external object, the electronic button 20 is simultaneously driven to power on the image detector 42. The image detector 42 can receive an image signal (such as a shadow) from the reflection bar 38, the controller 26 can calculate a coordinate position of the shadow on the base 36 by triangulation, and further output the corresponding command according to the coordinate position.

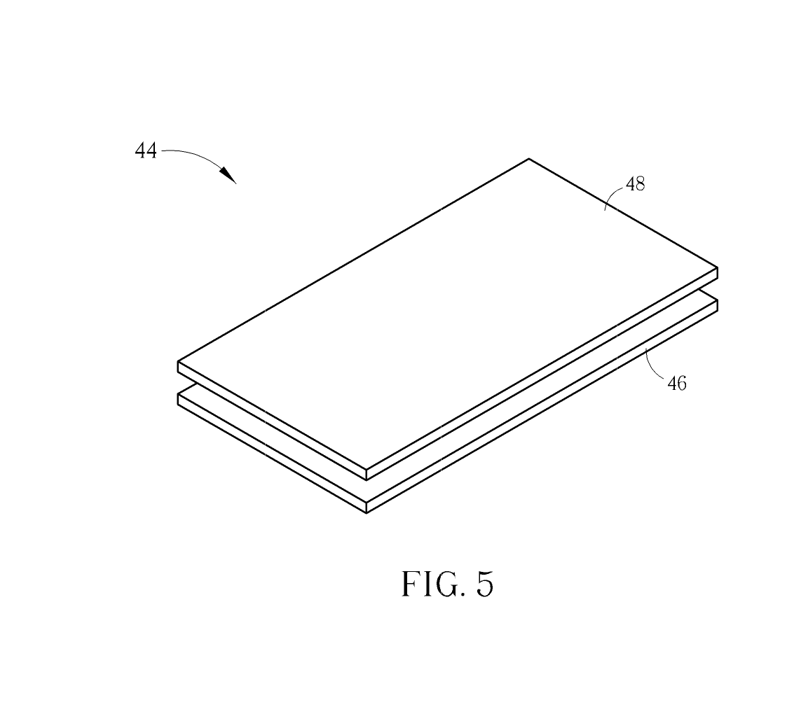

Please refer to FIG. 5. FIG. 5 is a diagram of a touch panel 44 according to the other embodiment of the present invention. The touch panel 44 can be a resistive touch screen. The resistive touch screen includes a first conductive layer 46 and a second conductive layer 48. The second conductive layer 48 is disposed upon the first conductive layer 46 without contact, which means the second conductive layer 48 is a touch layer of the resistive touch screen and is separated from the first conductive layer 46. When the external object contacts the resistive touch screen, the transparent conductive structure 24 drives the switch 22 to transmit the current into the first conductive layer 46 and the second conductive layer 48 due to variation of the reference value. The second conductive layer 48 is deformably pressed to partly contact the first conductive layer 46 (a part of the second conductive layer 48 whereon the external object is placed contacts the first conductive layer 46), a voltage variation is generated due to connection between the first conductive layer 46 and the second conductive layer 48, and the controller 26 can calculate the coordinate position of the contact point according to the voltage variation, so as to output the corresponding command.

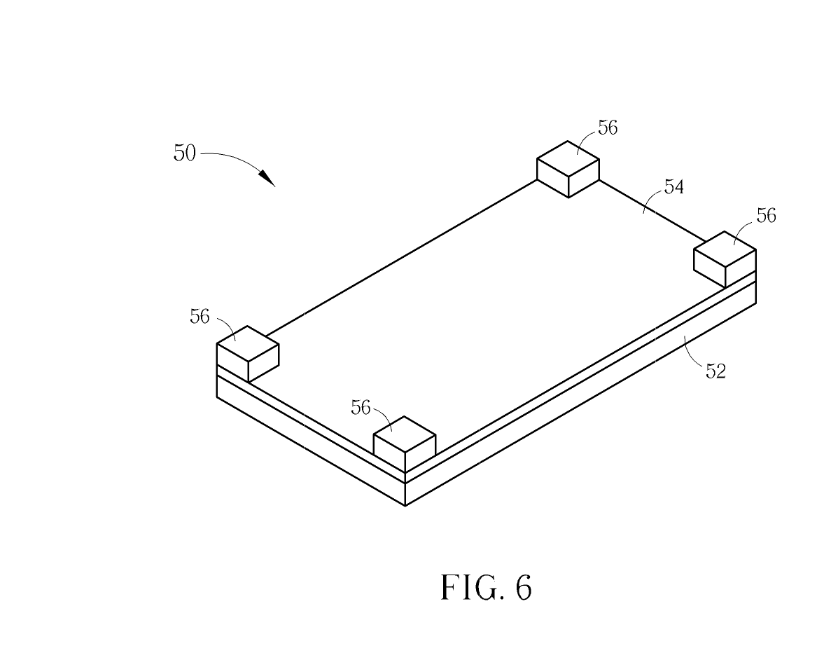

Please refer to FIG. 6. FIG. 6 is a diagram of a touch panel 50 according to the other embodiment of the present invention. The touch panel 50 can be a capacitive touch screen. The capacitive touch screen includes a plate member 52 and an electrode 54. The electrode 54 is disposed on an upper surface of the plate member 52. When the external object contacts the capacitive touch screen, a capacitance variation is generated by connection between the external object and the electrode 54. An induced current is then generated to transmit toward receivers 56 disposed on four corners of the plate member 52. The receivers 56 are actuated by the electronic button 20. The induced current transmitted to the four receivers 56 corresponds to distance between the external object and the four corners of the plate member 52, so that the controller 26 can calculate the coordinate position of the external object according to value of the induced current, so as to output the corresponding command.

The touch screen applied to the panel module 14 of the present invention is not limited to the optical image touch screen, the resistive touch screen and the capacitive touch screen mentioned as above, which depends on design demand, and detailed description is omitted herein for simplicity. It should be mentioned that a conductive membrane of the electronic button 20 can be made of opaque material when the touch panel 50 is a non-optical touch panel, such as the resistive touch screen. Function of the conductive membrane is the same as the above-mentioned transparent conductive structure 24, and the conductive membrane is not shown in figures. Therefore, the conductive membrane applied to the electronic button of the non-optical touch panel has the flexibility, and the transmittance is not necessary.

In conclusion, the present invention covers the transparent conductive structure on the upper surface of the touch panel (such as the light emitting surface of the light guide plate), so as to form the button to adjust the detective function of the touch panel. Due to the great transmittance of the transparent conductive structure, the damage of the display function of the touch panel can be eliminated. And in the embodiments of the optical touch system, the optical detector of the touch panel can accurately capture the reflective optical signal from the external object through the light guide plate and the transparent conductive structure, so the optical touch detection of the panel module is not interfered. Besides, the transparent conductive structure further has great conductivity. The electronic device can utilize the power supply to output the stable minority current into the transparent conductive structure. As the external object contacts and not contact the transparent conductive structure, the reference value of the minority current can be decreased and increased, so as to drive the switch the power on and to power off the optical detector of the touch panel. Therefore, the present invention can ensure that the optical touch detection of the panel module is actuated when the external object contacts the touch panel (or the external object contacts the transparent conductive structure disposed on the touch panel), and can prevent the optical detector from error detection by capturing an unexpected image.

Comparing to the prior art, the present invention transmits the stable minority current into the transparent conductive structure, the current variation is generated when the external object contacts the transparent conductive structure, so the transparent conductive structure can be combined with the switch to be the electronic button to power on and to power off the touch panel. The present invention disposes the transparent conductive structure with the great transmittance on the optical touch panel to form the electronic button. Thus, the optical electronic device of the present invention does not capture the unexpected movement of the external object, and can accurately determine indication of the user for outputting the correct command.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic button applied to a touch panel, the electronic button comprising:
a switch electrically connected to the touch panel for switching operational functions of the touch panel; and
a transparent conductive structure electrically connected to the switch and disposed on a surface of the touch panel, the transparent conductive structure transmitting a current, a reference value of the current being varied when an external object contacts the transparent conductive structure so as to drive the switch to power on and to power off the touch panel.

2. The electronic button of claim 1, wherein the reference value of the current is a voltage value, a current value or a resistance value.

3. The electronic button of claim 1, wherein the reference value includes a first value, the reference value is varied from the first value to a second value when the external object contacts the transparent conductive structure, and the transparent conductive structure drives the switch to power on the touch panel.

4. The electronic button of claim 3, wherein the reference value is varied form the second value to the first value when the external object is spaced from the transparent conductive structure, and the transparent conductive structure drives the switch to power off the touch panel.

5. The electronic button of claim 1, wherein the transparent conductive structure is made of indium tin oxide material, aluminum zinc oxide material or gallium-doping zinc oxide material.

6. An electronic button applied to a touch panel, the electronic button comprising:
a switch electrically connected to the touch panel for switching operational functions of the touch panel; and
a conductive membrane electrically connected to the switch and disposed on a surface of the touch panel, the conductive membrane transmitting a current, a reference value of the current being varied when an external object contacts the conductive membrane so as to drive the switch to power on and to power off the touch panel.

7. The electronic button of claim 6, wherein the reference value of the current is a voltage value, a current value or a resistance value.

8. The electronic button of claim 6, wherein the reference value includes a first value, the reference value is varied from the first value to a second value when the external object contacts the conductive membrane, and the conductive membrane drives the switch to power on the touch panel.

9. The electronic button of claim 8, wherein the reference value is varied form the second value to the first value when the external object is spaced from the conductive membrane, and the conductive membrane drives the switch to power off the touch panel.

10. A panel module comprising:
a touch panel for detecting an external object;
a power supply; and
an electronic button disposed on the touch panel, the electronic button comprising:
a switch electrically connected to the touch panel for switching operational functions of the touch panel; and
a transparent conductive structure electrically connected to the switch and the power supply and disposed on a surface of the touch panel, the power supply outputting a current to the transparent conductive structure, a reference value of the current being varied when the external object contacts the transparent conductive structure so as to drive the switch to power on and to power off the touch panel.

11. The panel module of claim 10, wherein the reference value of the current is a voltage value, a current value or a resistance value.

12. The panel module of claim 10, wherein the touch panel comprises:
a light guide plate, the light guide plate comprising a light emitting surface;
a light unit disposed by a side of the light guide plate, the light unit providing a light beam into the light guide plate, and the light beam being away from the light guide plate via the light emitting surface; and
an optical detector disposed under the light guide plate, the optical detector receiving a reflective optical signal generated from the external object when the external object is placed on the light emitting surface.

13. The panel module of claim 12, wherein the reference value includes a first value, the reference value is varied from the first value to a second value when the external object contacts the transparent conductive structure, and the transparent conductive structure drives the switch to power on the optical detector.

14. The panel module of claim 13, wherein the reference value is varied form the second value to the first value when the external object is spaced from the transparent conductive structure, and the transparent conductive structure drives the switch to power off the optical detector.

15. The panel module of claim 10, wherein the transparent conductive structure is made of indium tin oxide material, aluminum zinc oxide material or gallium-doping zinc oxide material.

16. The panel module of claim 10, wherein the power supply is a direct current power supply.

17. An electronic device comprising:
a casing;
a panel module disposed on a surface of the casing, the panel module comprising:
a touch panel for detecting an external object;
a power supply; and
an electronic button disposed on the touch panel, the electronic button comprising:
a switch electrically connected to the touch panel for switching operational functions of the touch panel; and
a transparent conductive structure electrically connected to the switch and the power supply and disposed on a surface of the touch panel, the power supply outputting a current to the transparent conductive structure, a reference value of the current being varied when the external object contacts the transparent conductive structure so as to drive the switch to power on and to power off the touch panel; and
a controller electrically connected to the touch panel, the controller outputting a command according to detection of the external object by the touch panel.

18. The electronic device of claim 17, wherein the reference value of the current is a voltage value, a current value or a resistance value.

19. The electronic device of claim 17, wherein the touch panel of the panel module comprises:
a light guide plate, the light guide plate comprising a light emitting surface;
a light unit disposed by a side of the light guide plate, the light unit providing a light beam into the light guide plate, and the light beam being away from the light guide plate via the light emitting surface; and
an optical detector disposed under the light guide plate, the optical detector receiving a reflective optical signal generated from the external object when the external object is placed on the light emitting surface, and the controller outputting the command according to the detection of the optical detector.

20. The electronic device of claim 19, wherein the reference value includes a first value, the reference value is varied from the first value to a second value when the external object contacts the transparent conductive structure, and the transparent conductive structure drives the switch to power on the optical detector.

21. The electronic device of claim 20, wherein the reference value is varied form the second value to the first value when the external object is spaced from the transparent conductive structure, and the transparent conductive structure drives the switch to power off the optical detector.

22. The electronic device of claim 17, wherein the touch panel is an optical image touch screen, the optical image touch screen comprises:
a base;
a reflection bar disposed on an edge of the base;
a light guide bar disposed on the other edge of the base, the light guide bar providing a light beam to the reflection bar; and
at least one image detector disposed on a corner of the base, the image detector receiving an image signal generated from the reflection bar when the light beam is blocked by the external object, and the controller outputting the command according to the image signal.

23. The electronic device of claim 17, wherein the touch panel is a resistive touch screen, the resistive touch screen comprises:
a first conductive layer; and
a second conductive layer separated from the first conductive layer, the second conductive layer contacting the first conductive layer when the external object is put on the resistive touch screen, and the controller outputting the command according to a voltage variation by connection of the second conductive layer and the first conductive layer.

24. The electronic device of claim 17, wherein the touch panel is a capacitive touch screen, the capacitive touch screen comprises:
a plate member; and
an electrode disposed on a surface of the plate member, a capacitance variation being generated when the external object contacts the electrode, and the controller outputting the command according to an induced current generated by the capacitance variation.

25. The electronic device of claim 17, wherein the transparent conductive structure is made of indium tin oxide material, aluminum zinc oxide material or gallium-doping zinc oxide material.

26. The electronic device of claim 17, wherein the power supply is a direct current power supply.
